(19) United States
(12) Patent Application Publication
(10) Pub. No.: US 2025/0252459 A1
(43) Pub. Date: Aug. 7, 2025

(54) VEHICLE NAVIGATION DEVICE AND METHOD OF CONTROLLING THE SAME

(71) Applicants: Hyundai Motor Company, Seoul (KR); Kia Corporation, Seoul (KR)

(72) Inventor: Gyu Young LEE, Yongin-si (KR)

(73) Assignees: Hyundai Motor Company, Seoul (KR); Kia Corporation, Seoul (KR)

(21) Appl. No.: 18/885,932

(22) Filed: Sep. 16, 2024

(30) Foreign Application Priority Data
Feb. 6, 2024 (KR) 10-2024-0018320

(51) Int. Cl. G06Q 30/0251; G01C 21/00

(52) U.S. Cl. CPC G06Q 30/0266; G01C 21/3811

(57) ABSTRACT

In a vehicle navigation device and a control method thereof, and to a vehicle navigation device for improving advertising effects on users by displaying advertising data corresponding to a user's schedule to the user, and a control method thereof, the method of controlling a vehicle navigation device includes the steps of: obtaining information of a preset type from a mobile device; and outputting advertising data matching the obtained information of the preset type through a display unit when preset output conditions are satisfied, and the information of a preset type may include schedule information.

### CROSS REFERENCE TO RELATED APPLICATION

The present application claims priority to Korean Patent Application No. 10-2024-0018320, filed on Feb. 6, 2024, the entire contents of which is incorporated herein for all purposes by this reference.

### BACKGROUND OF THE PRESENT DISCLOSURE

### Field of the Present Disclosure

The present disclosure relates to a vehicle navigation device and a control method thereof, and more specifically, to a vehicle navigation device for improving advertising effects on users by displaying advertising data corresponding to a user's schedule to the user, and a control method thereof.

### Description of Related Art

A conventional navigation device mounted on a vehicle shows the current location and travelling direction of the vehicle through a display device using information received from Global Positioning System (GPS) satellites, and when a destination is input, the navigation device displays the roads, distance, and estimated time of the vehicle to travel on the screen based on the current location.

Such a route display function provides more optimized route information using real-time traffic information and even provides a multimedia contents playback function. As the time of a user staying in a vehicle increases, functions that can increase user's convenience, e.g., a function of providing information for advertising businesses around the current location or the route, may be provided using the navigation device.

Meanwhile, as the number of drivers using portable terminals or mobile devices increases, the functions interconnecting the navigation device in the vehicle with the driver's mobile device are getting more diverse. When the navigation device in the vehicle is connected to the mobile device, the user's schedule stored or registered in the mobile device is also linked to the navigation device. However, in a general navigation device, although the navigation device is connected to the mobile device, information obtained through the connection is not linked to other functions such as the advertisement or the like described above, but is simply output.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle navigation device for improving advertising effects on users by displaying advertising data corresponding to a user's schedule to the user, and a control method thereof.

The technical problems to be solved by an exemplary embodiment of the present disclosure are not limited to the technical problems mentioned above, and unmentioned other technical problems will be clearly understood by those skilled in the art from the following description.

A method of controlling a navigation device according to various exemplary embodiments of the present disclosure may include the steps of: obtaining information of a preset type from a mobile device; and outputting advertising data matching the obtained information of the preset type through a display unit when preset output conditions are satisfied, wherein the information of the preset type includes schedule information.

For example, the control method may further include the steps of: transmitting the information of the preset type to an advertising system; and receiving the matching advertising data from the advertising system.

For example, the transmitting step may include the step of transmitting at least one among current location information and route information to the advertising system.

For example, the matching advertising data may be determined by the advertising system based on at least one among the schedule information, the current location information, and the route information.

For example, the preset output conditions may include at least one among a case where the current location is within a predetermined distance from a place corresponding to the matching advertising data, a case where the corresponding place is located within a map output through the display unit, and a case where the current time point corresponds to a recommended display time point corresponding to the advertising data.

For example, the schedule information may include at least one among a date, a type, and a place.

For example, the recommended display time point may be determined by the navigation device or the advertising system that provides the advertising data according to the schedule information.

For example, the control method may further include the step of, when the recommended display time point is determined by the advertising system, receiving information on the recommended display time point from the advertising system.

For example, the control method may further include the steps of: transmitting at least one among current location information and route information to an advertising system; and receiving advertising data corresponding to at least one among the current location information and the route information from the advertising system.

For example, the outputting step may include the steps of: determining advertising data matching the obtained information of the preset type among the received advertising data; and outputting the determined matching advertising data.

Furthermore, a navigation device according to various exemplary embodiments of the present disclosure may include: a communication unit; a display unit; and a control unit for controlling to obtain information of a preset type from a mobile device through the communication unit, and output advertising data matching the obtained information of the preset type through the display unit when preset output conditions are satisfied, wherein the information of a preset type may include schedule information.

For example, the control unit may be configured for controlling to transmit the information of the preset type to an advertising system through the communication unit, and obtain the matching advertising data from the advertising system.

For example, the control unit may be configured for controlling to transmit at least one among current location information and route information to the advertising system through the communication unit.

For example, the matching advertising data may be determined by the advertising system based on at least one among the schedule information, the current location information, and the route information.

For example, the preset output conditions may include at least one among a case where the current location is within a predetermined distance from a place corresponding to the matching advertising data, a case where the corresponding place is located within a map output through the display unit, and a case where the current time point corresponds to a recommended display time point corresponding to the advertising data.

For example, the schedule information may include at least one among a date, a type, and a place.

For example, the recommended display time point may be determined by the navigation device or the advertising system that provides the advertising data according to the schedule information.

For example, when the recommended display time point is determined by the advertising system, the control unit may be configured for controlling to receive information on the recommended display time point from the advertising system through the communication unit.

For example, the control unit may be configured for controlling to transmit at least one among current location information and route information to an advertising system through the communication unit, and obtain advertising data corresponding to at least one among the current location information and the route information from the advertising system through the communication unit.

For example, the control unit may be configured to determine advertising data matching the obtained information of the preset type among the received advertising data, and control to output the determined matching advertising data through the output unit.

According to the vehicle navigation device of the present disclosure and a control method thereof, as advertising data corresponding to a user's schedule is displayed to the user, advertising effects on the user may be improved.

The effects which may be obtained from the present disclosure are not limited to the effects mentioned above, and unmentioned other effects may be clearly understood by those skilled in the art from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing a vehicle navigation device according to an exemplary embodiment of the present disclosure.

FIG. 2 is a flowchart illustrating an example of a control method of a navigation device 30 according to an exemplary embodiment of the present disclosure.

FIG. 3 is a flowchart illustrating another example of a control method of a navigation device 30 according to an exemplary embodiment of the present disclosure.

FIG. 4 is a view showing an example of advertising data output through a display unit according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the exemplary embodiments included in the present specification will be described in detail with reference to the accompanying drawings, and the same reference numerals are provided to the same or similar components regardless of reference symbols, and duplicate description thereof will be omitted.

The suffixes “module” and “unit” for the components used in the following description are assigned or interchangeably used only to facilitate creation of the specification, and do not include a meaning or role distinguished from each other by themselves.

When it is determined, in describing the exemplary embodiments included in the present specification, that the detailed descriptions of related known techniques may obscure the gist of the exemplary embodiments included in the present specification, the detailed description will be omitted. Furthermore, the accompanying drawings are only for easy understanding of the exemplary embodiments included in the present specification, and the technical spirit included in the present specification is not limited by the accompanying drawings, and should be understood to include all changes, equivalents, and substitutes included in the spirit and technical scope of the present disclosure. Although terms including ordinal numbers such as first, second, and the like may be used to describe various components, the components are not limited by the terms. The terms are used only to distinguish one component from the others.

When a component is mentioned as being “connected” or “coupled” to another component, it should be understood that although the component may be directly connected or coupled to another component, other components may exist in the middle. On the other hand, when a component is mentioned as being “directly connected” or “directly coupled” to another element, it should be understood that no other component exists in the middle.

Singular expressions include plural expressions unless the context clearly dictates otherwise.

In the present specification, terms such as “comprise”, “have”, and the like are intended to indicate presence of a feature, a number, a step, an operation, a component, part, or a combination thereof described in the specification, and it should be understood that the terms do not preclude the possibility of presence or addition of one or more other features, numbers, steps, operations, components, parts, or combinations thereof.

Furthermore, the units or control units included in the names of a motor control unit (MCU), a hybrid control unit (HCU), and the like ae only terms widely used in naming a control device that is configured to control specific functions of a vehicle, and do not mean a generic function unit.

The control unit may include a communication device for communicating with other control units or sensors to control functions in charge, a memory for storing an operating system, logic instructions, input/output information, and the like, and one or more processors for making determinations, operations, decisions, and the like needed to control the functions in charge.

According to an exemplary embodiment of the present disclosure, advertising effects on a user may be improved by displaying advertising data corresponding to a user's schedule to the user.

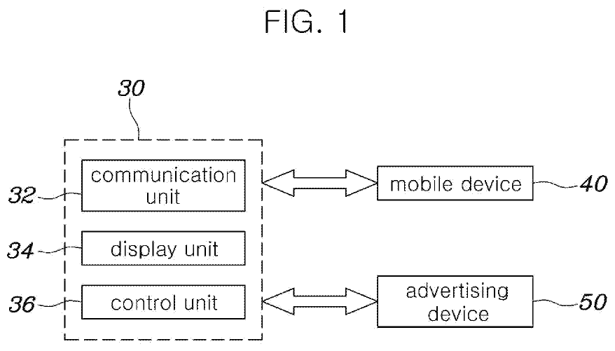

FIG. 1 is a block diagram showing a vehicle navigation device according to an exemplary embodiment of the present disclosure. FIG. 1 mainly shows components related to the exemplary embodiment of the present disclosure, and of course, in implementing an actual vehicle navigation device, it may include fewer or more components.

As shown in FIG. 1, a vehicle navigation device 30 includes a communication unit 32 for exchanging data with a mobile device 40 and an advertising system 50, a display unit 34 for displaying a predetermined image under the control of a control unit, and the control unit 36 for controlling to display advertising information selected based on information obtained from the mobile device 40 through the display unit 34.

Hereinafter, components 32, 34, and 36 of the navigation device 30 will be described in more detail.

The communication unit 32 may exchange data with the mobile device 40 through a wired communication protocol or a wireless communication protocol. For example, the wired communication protocol may include the Universal Serial Bus (USB) protocol, and the wireless communication protocol may include at least one among Bluetooth, Bluetooth Low Energy (BLE), Zigbee, Ultra-Wide Band (UWB), and millimeter wave (mmWave).

Furthermore, the communication unit 32 may exchange data with the advertising system 50 through wireless connection. Although wireless connection with the advertising system 50 may be performed through a wireless communication protocol such as 3G/4G (Long Term Evolution, LTE)/5G, this is an example and is not necessarily limited thereto.

The display unit 34 may be implemented as a display device of an Audio/Video/Navigation/Telematics (AVNT) system, but this is an example, and the display unit 34 may be another display device in the vehicle, for example, a display of a cluster, a head-up display (HUD), a window glass, or a roof glass. According to implementations, the display unit 34 may be an external display, which is arranged in the vicinity of the vehicle or visible to a passenger inside the vehicle. In the instant case, the external display is linked to the location of the vehicle to display advertising information or the like in a situation close to the vehicle so that the passenger may see the advertising information. As described above, the display unit 34 is not limited to any form or arranged location as long as the passengers on the vehicle can visually confirm the advertising data.

The control unit 36 may be configured for controlling the communication unit 32 and the display unit 34 described above. In more detail, the control unit 36 may be configured for controlling the communication unit 32 to establish a wired or wireless data path with the mobile device 40 and receive information of a preset type from the mobile device 40 through the established data path. For example, the information of a preset type may be information on the schedule. Here, the schedule information may include at least one among the name, date, time, type, and location of a schedule.

However, this is an example and is not limited to any type of information, such as personal information, preference information, or the like, as long as it is information which may be used as a basis for selecting advertising data.

The control unit 36 may be configured for controlling the obtained information to be transmitted to the advertising system 50 through the communication unit 32, and when advertising data is received from the advertising system 50 through the communication unit 32, it may output the advertising data in a predetermined format through the display unit 34. To the present end, the control unit 36 may include a memory for storing an operating system, logic instructions, input/output information, and the like, and one or more processors for making determinations, operations, decisions, and the like needed to control the functions in charge.

At the present point, the advertising data received from the advertising system 50 may be advertising data corresponding to the information obtained through the mobile device 40. For example, when the information obtained through the mobile device 40 is schedule information, advertising data about a place where goods or services necessary for performing the schedule are provided may be received. Furthermore, according to another aspect of the exemplary embodiment of the present disclosure, the control unit 36 may keep the information obtained through the mobile device 40 and does not transmit the information to the advertising system 50. In the instant case, the advertising system 50 transmits the advertising data based on the location or route of the vehicle provided with the navigation device 30, and the control unit 36 may select advertising data to be output through the display unit 34 by matching the received advertising data and the information obtained through the mobile device 40.

The mobile device 40 is a portable computing device used by a driver, a passenger, or a person adjacent to the vehicle, and may include at least one among a portable PC, a laptop, a mobile phone, a smartphone, and a smart tablet. The mobile device 40 may store the user's schedule, personal information, and the like, and transmit the stored information to the navigation device 30 when it is connected to the navigation device 30. Although it is assumed in the exemplary embodiments of the present disclosure that the mobile device 40 is a smartphone possessed by the driver or a passenger of the vehicle, this is for convenience of explanation, and the mobile device 40 is not necessarily limited thereto.

The advertising system 50 may exchange data with the navigation device 30 through wireless communication. For example, the advertising system 50 may be implemented as a function of a Connected Car Service (CCS) server.

The advertising system 50 may receive advertising data from advertisers, public relations companies, or the like and store the advertising data, and may receive location information or route information from the navigation device 30 of the vehicle and transmit advertising data corresponding to the location or route to the navigation device 30. Furthermore, when the advertising system 50 additionally receives information for selecting advertising data, such as schedule information or the like, from the navigation device 30 of the vehicle, it may select advertising data to be transmitted to navigation device 30 further considering (matching) the additionally received information. To the present end, the advertising system 50 may select highly-related advertising information by comparing the date, type, and location of the schedule information, weather information of the date, and the like with advertising information previously possessed. Of course, the term highly-related means that various methods, such as determining a score by indexing the comparison target information described above (date, type, location, weather information of the date) and applying a weight, may be used.

For example, the advertising system 50 may be configured to determine advertising data for a place located within a predetermined distance from the location or route of the vehicle and related to the additionally received schedule as data to be transmitted to the navigation device 30.

When additional information set in the mobile device 40 of the driver and then transmitted to the advertising system 50 through the navigation device 30 is a dinner party schedule, data for advertising the brands or affiliated stores of hangover-relieving food matching thereto (i.e., is highly related) may be determined as advertising data to be transmitted to the navigation device 30. Furthermore, when a wedding schedule is set, advertising data for beauty brands such as skin care shops or beauty salons highly related thereto may be selected, and when a golf meeting schedule is set, advertising data for a screen golf course may be selected in the advertising system 50. As an exemplary embodiment of the present disclosure, when a mountaineering meeting is set, advertising data for oriental medical clinics and orthopedics, as well as mountaineering supplies, may be selected. of course, the results of matching the schedule information and the advertising data described above are illustrative and not necessarily limited thereto.

Furthermore, the advertising system 50 may also transmit information on recommended display time points, such as before or after a corresponding schedule, to the navigation device 30, together with the advertising data, according to the type of the matched schedule.

For example, when the additional information is a dinner party schedule and the selected advertising data corresponds to a brand of hangover-relieving soup, the recommended display time point may be set to the morning of the next day of the dinner party schedule. As an exemplary embodiment of the present disclosure, when the additional information is a wedding schedule and the selected advertising data corresponds to a beauty brand such as a skin care shop or a beauty salon, the recommended display time point may be 2 to 3 days before the wedding. Furthermore, when the additional information is a golf meeting schedule and the selected advertising data corresponds to a screen golf course, the recommended display time point may be a week before the golf meeting. As an exemplary embodiment of the present disclosure, when the additional information is a mountaineering meeting and the selected advertising data corresponds to mountaineering supplies, oriental medical clinics, and orthopedics, the recommended display time point for the mountaineering supplies may be a predetermined time period before the mountaineering meeting, and the recommended display time point for the oriental medical clinics and orthopedics may be after the mountaineering meeting.

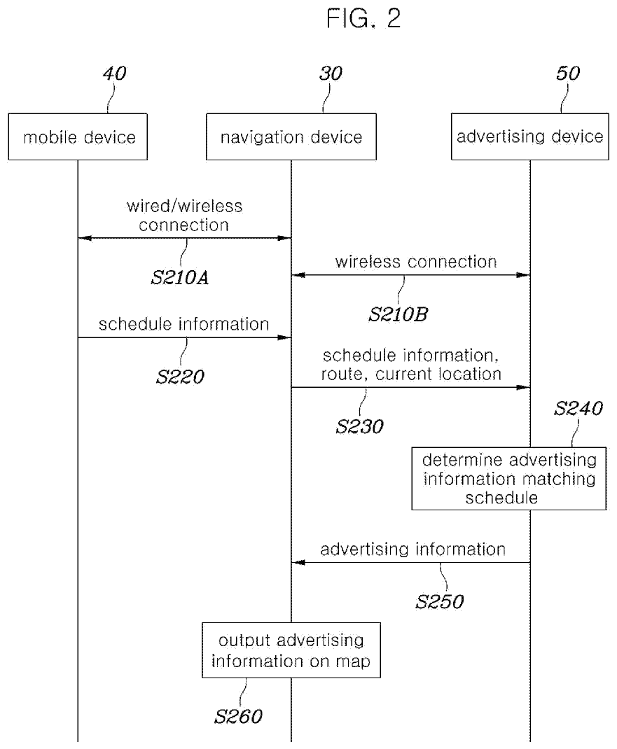

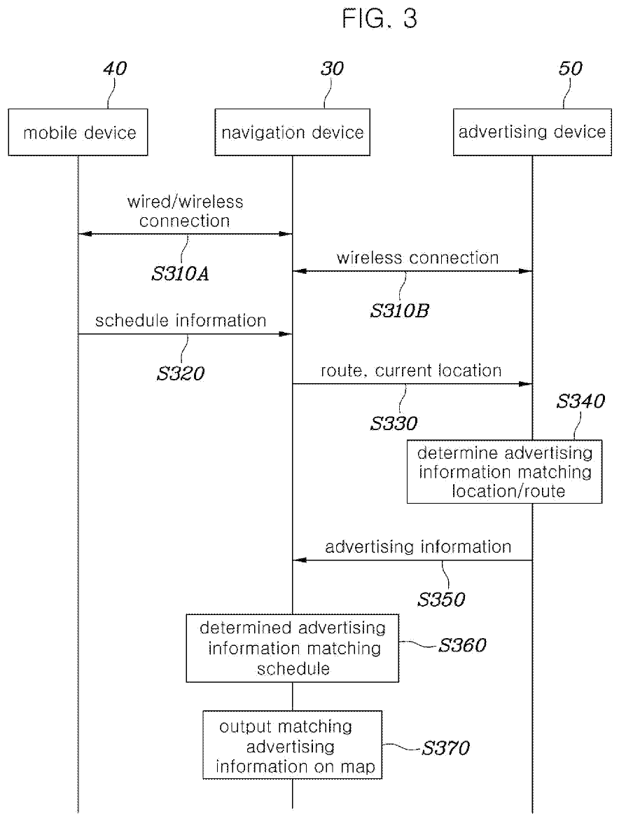

A control method of the navigation device 30 according to an exemplary embodiment will be described with reference to FIG. 2 and FIG. 3 based on the configuration of the vehicle navigation device 30 described above. In FIG. 2 and FIG. 3, it is assumed that additional information for selecting advertising data is schedule information set in the mobile device 40 for the sake of convenience.

FIG. 2 is a flowchart illustrating an example of a control method of a navigation device 30 according to an exemplary embodiment of the present disclosure.

Referring to FIG. 2, the navigation device 30 may be connected to the mobile device 40 through wired or wireless communication (S210A) and may be connected to the advertising system 50 through wireless communication (S210B). Either the connections (S210A and S210B) may be established first.

The navigation device 30 may obtain schedule information from the mobile device 40 (S220), and the obtained schedule information may be transmitted to the advertising system 50 (S230). At the present point, the navigation device 30 may transmit information on at least one among the route and the current location, together with the schedule information, to the advertising system 50, and the route or current location may not be necessarily transmitted at the same time as the schedule information.

The advertising system 50 may be configured to determine advertising information matching the information obtained from the navigation device 30 (S240). For example, the advertising system 50 may select advertising information located within a predetermined distance from the current location or route of the vehicle provided with the navigation device 30 and matching to a place related to schedule information. As described above, determination of advertising information may be accompanied by determination of a recommended output time point.

The advertising system 50 may transmit the determined advertising information to the navigation device 30 (S250), and the navigation device 30 may output advertising information that satisfies preset output conditions among the received advertising information on a map displayed through the display unit 34 (S260). Here, the preset output conditions may include at least one among a case where a place corresponding to the advertising information is located on the currently displayed map, a case where a place corresponding to the advertising information is located within a preset distance from the current location, and a case where the current time point corresponds to a recommended output time point. However, these output conditions are illustrative and not necessarily limited thereto.

Meanwhile, although the advertising system 50 matches schedule information and advertising information in the control method shown in FIG. 2, according to another implementation, the navigation device 30 may match the schedule information and the advertising information. This is described with reference to FIG. 3.

FIG. 3 is a flowchart illustrating another example of a control method of a navigation device 30 according to an exemplary embodiment of the present disclosure.

Referring to FIG. 3, the navigation device 30 may be connected to the mobile device 40 through wired or wireless communication (S310A) and may be connected to the advertising system 50 through wireless communication (S310B). Either the connections (S310A, S310B) may be established first.

The navigation device 30 may obtain schedule information from the mobile device 40 (S320). However, unlike the case of FIG. 2, the obtained schedule information may not be transmitted to the advertising system 50, and information on at least one among the route and the current location may be transmitted to the advertising system 50 (S330).

The advertising system 50 may be configured to determine advertising information matching the information obtained from the navigation device 30 (S340). For example, the advertising system 50 may select advertising information located within a predetermined distance from the current location or route of the vehicle provided with the navigation device 30.

The advertising system 50 may transmit the determined advertising information to the navigation device 30 (S350), and the navigation device 30 may be configured to determine advertising information matching the schedule information obtained from the mobile device 40 among the received advertising information (S360). At the present point, determination of advertising information based on the schedule information performed in the navigation device 30 may be accompanied by determination of a recommended output time point.

Thereafter, the navigation device 30 may output advertising information that satisfies preset output conditions on a map displayed through the display unit 34 (S370). Here, the preset output conditions may include at least one among a case where a place corresponding to the advertising information is located on the currently displayed map, a case where a place corresponding to the advertising information is located within a preset distance from the current location, and a case where the current time point corresponds to a recommended output time point. However, these output conditions are illustrative and not necessarily limited thereto.

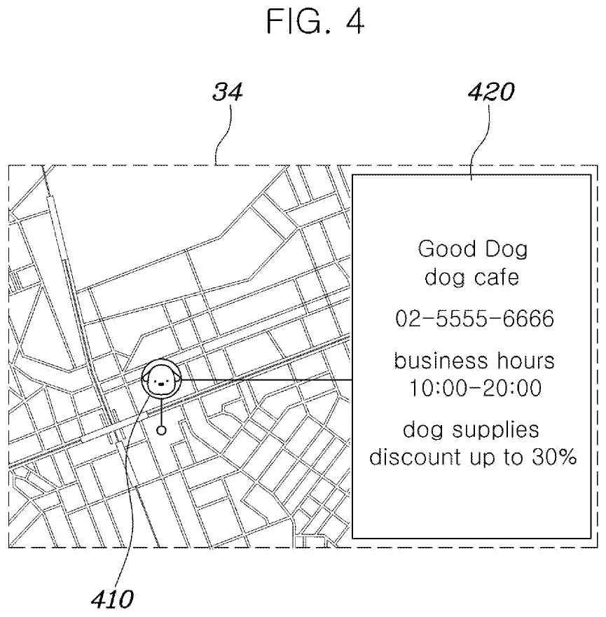

FIG. 4 is a view showing an example of advertising data output through a display unit 34 according to an exemplary embodiment of the present disclosure.

In FIG. 4, it is assumed that the schedule information is a dog club meeting, and accordingly, the advertising information selected by the advertising system 50 or the navigation device 30 based on the schedule information is a dog cafe.

Referring to FIG. 4, the advertising information may be in a form of a brand pin 410 located on a map displayed through the display unit 34. Together with the brand pin 410, additional information 420 on the business place corresponding to the brand pin 410 may be further displayed optionally. The additional information 420 may include information such as the business name, business hours, and discount information of a corresponding business place. The additional information may enhance convenience of customers visiting the store and effectively attract the customers.

According to the exemplary embodiments of the present disclosure described above, as advertising data corresponding to a user's schedule is displayed to the user, advertising effects on the user may be improved.

The method according to an exemplary embodiment described above may be produced as a program to be executed on a computer and stored in a computer-readable recording medium. Examples of the computer-readable recording medium include ROM, RAM, CD-ROM, magnetic tape, floppy disk, optical data storage device, and the like, and furthermore, include those implemented in a form of carrier waves (e.g., transmission through the Internet).

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned disclosure can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling a navigation device, the method comprising:
obtaining, by the navigation device, information of a preset type from a mobile device; and
outputting, by the navigation device, advertising data matching the obtained information of the preset type through a display unit of the navigation device in response that preset output conditions are satisfied,
wherein the information of the preset type includes schedule information.

2. The method of claim 1, further including:
transmitting, by the navigation device, the information of the preset type to an advertising system; and
receiving, by the navigation device, the matching advertising data from the advertising system.

3. The method of claim 2, wherein the transmitting of the information of the preset type includes transmitting at least one of current location information or route information to the advertising system.

4. The method of claim 3, wherein the matching advertising data is determined by the advertising system based on at least one of the schedule information, the current location information, or the route information.

5. The method of claim 1, wherein the preset output conditions include at least one of a case where a current location of the navigation apparatus is within a predetermined distance from a place corresponding to the matching advertising data, a case where the corresponding place is located within a map output through the display unit, or a case where a current time point corresponds to a recommended display time point corresponding to the advertising data.

6. The method of claim 5, wherein the schedule information includes at least one of a date, a type, or a place of the schedule information.

7. The method of claim 6, wherein the recommended display time point is determined by the navigation device or the advertising system that provides the advertising data according to the schedule information.

8. The method of claim 7, further including, in response that the recommended display time point is determined by the advertising system, receiving information on the recommended display time point from the advertising system.

9. The method of claim 1, further including:
transmitting, by the navigation device, at least one of current location information or route information to an advertising system; and
receiving, by the navigation device, advertising data corresponding to at least one of the current location information or the route information from the advertising system.

10. The method of claim 9, wherein the outputting includes:
determining, by the navigation device, the advertising data matching the obtained information of the preset type among the received advertising data; and
outputting, by the navigation device, the determined matching advertising data, through the display unit.

11. A navigation apparatus comprising:
a communication unit;
a display unit; and
a control unit operably connected to the communication unit and the display unit and configured to obtain information of a preset type from a mobile device through the communication unit, and output advertising data matching the obtained information of the preset type through the display unit in response that preset output conditions are satisfied,
wherein the information of the preset type includes schedule information.

12. The navigation apparatus of claim 11, wherein the control unit is further configured to transmit the information of the preset type to an advertising system through the communication unit, and obtain the matching advertising data from the advertising system.

13. The navigation apparatus of claim 12, wherein the control unit is further configured to transmit at least one of current location information or route information to the advertising system through the communication unit.

14. The navigation apparatus of claim 13, wherein the matching advertising data is determined by the advertising system based on at least one of the schedule information, the current location information, or the route information.

15. The navigation apparatus of claim 11, wherein the preset output conditions include at least one of a case where a current location of the navigation apparatus is within a predetermined distance from a place corresponding to the matching advertising data, a case where the corresponding place is located within a map output through the display unit, or a case where a current time point corresponds to a recommended display time point corresponding to the advertising data.

16. The navigation apparatus of claim 15, wherein the schedule information includes at least one of a date, a type, or a place of the schedule information.

17. The navigation apparatus of claim 16, wherein the recommended display time point is determined by the navigation device or the advertising system that provides the advertising data according to the schedule information.

18. The navigation apparatus of claim 17, wherein in response that the recommended display time point is determined by the advertising system, the control unit is further configured to receive information on the recommended display time point from the advertising system through the communication unit.

19. The navigation apparatus of claim 11, wherein the control unit is further configured to transmit at least one of current location information or route information to an advertising system through the communication unit, and obtain advertising data corresponding to at least one of the current location information or the route information from the advertising system through the communication unit.

20. The navigation apparatus of claim 19, wherein the control unit is further configured to determine the advertising data matching the obtained information of the preset type among the received advertising data, and output the determined matching advertising data through an output unit.
